(19) United States
(12) Patent Application Publication
(10) Pub. No.: US 2024/0054270 A1
(43) Pub. Date: Feb. 15, 2024

(54) FLOW BEHAVIOR PREDICTION SYSTEM, FLOW BEHAVIOR PREDICTION METHOD, AND COMPUTER PROGRAM PRODUCT

(71) Applicant: KABUSHIKI KAISHA TOSHIBA, Tokyo (JP)

(72) Inventors: Aya KITOH, Yokohama (JP); Tomohiko JIMBO, Fujisawa (JP)

(73) Assignee: KABUSHIKI KAISHA TOSHIBA, Tokyo (JP)

(21) Appl. No.: 18/170,673

(22) Filed: Feb. 17, 2023

(30) Foreign Application Priority Data
Aug. 9, 2022 (JP) 2022-127479

(51) Int. Cl. G06F 30/28

(52) U.S. Cl. CPC G06F 30/28; G06F 2113/08

(57) ABSTRACT

According to one embodiment, a flow behavior prediction system includes a storage unit, an acquisition unit, and a three-dimensional estimation unit. The storage unit stores therein two-dimensional data of a plurality of basic shapes forming an object. The acquisition unit acquires first state data including a velocity of a fluid for the object at a first time point and a direction of the fluid at the first time point. The three-dimensional estimation unit estimates second state data including a velocity of the fluid for the object at a second time point that is more advanced than the first time point and a direction of the fluid at the second time point using a three-dimensional estimation network to estimate a three-dimensional behavior of the fluid for the object from a two-dimensional behavior of the fluid for the object estimated from the two-dimensional data and the first state data.

### CROSS-REFERENCE TO RELATED APPLICATIONS

This application is based upon and claims the benefit of priority from Japanese Patent Application No. 2022-127479, filed on Aug. 9, 2022; the entire contents of which are incorporated herein by reference.

### FIELD

Embodiments described herein relate generally to a flow behavior prediction system, a flow behavior prediction method, and a computer program product.

### BACKGROUND

Fluid simulation often requires a huge amount of computation time, making it difficult to apply fluid simulation to real-time system operation.

### BRIEF DESCRIPTION OF THE DRAWINGS

FIG. 1 is a diagram illustrating an example of an equipment configuration of a flow behavior prediction system according to an embodiment;

FIG. 2 is a diagram illustrating an example of a functional configuration of an information processing device according to the embodiment;

FIG. 3 is a diagram illustrating an example of a flow behavior prediction method according to an embodiment;

FIG. 4 is a flowchart illustrating an example of the flow behavior prediction method according to the embodiment; and

FIG. 5 is a diagram illustrating an example of a hardware configuration of an information processing device according to the embodiment.

### DETAILED DESCRIPTION

A flow behavior prediction system according to an embodiment includes a storage unit and one or more hardware processors configured to function as an acquisition unit and a three-dimensional estimation unit. The storage unit stores therein two-dimensional data of a plurality of basic shapes forming an object. The acquisition unit acquires first state data including a velocity of a fluid for the object at a first time point and a direction of the fluid at the first time point. The three-dimensional estimation unit estimates second state data including a velocity of the fluid for the object at a second time point that is more advanced than the first time point and a direction of the fluid at the second time point using a three-dimensional estimation network to estimate a three-dimensional behavior of the fluid for the object from a two-dimensional behavior of the fluid for the object estimated from the two-dimensional data and the first state data.

An object to be achieved by the embodiments herein is to provide a flow behavior prediction system, a flow behavior prediction method, and a computer program product capable of applying fluid simulation to real-time system operation.

The following is a detailed explanation of an embodiment of a flow behavior prediction system, a flow behavior prediction method, and a computer program product, with reference to the accompanying drawings.

The flow behavior prediction system according to the present embodiment uses a surrogate model (flow behavior prediction model) based on machine learning. The flow behavior prediction system according to the present embodiment can be applied, for example, to infrastructure service businesses that require instantaneous (real-time) flow prediction. The flow behavior prediction system according to the present embodiment predicts the flow around a three-dimensional object from a two-dimensional basic shape earlier than real time. For example, it can predict the flow around an infrastructure structure in response to inputs of wind velocity and a direction and perform digital twin control.

A flow behavior prediction system 100 according to the embodiment includes hardware resources, such as a central processing unit (CPU), a graphics processing unit (GPU), a read-only memory (ROM), a random-access memory (RAM), and a hard disk drive (HDD). For example, the flow behavior prediction system 100 is formed of a computer in which information processing by software is achieved using hardware resources, with a CPU and a GPU executing various computer programs. Furthermore, the flow behavior prediction model (surrogate model) is achieved by causing a computer to execute various computer programs.

Computer-based prediction uses prediction techniques based on learning from artificial intelligence. For example, it is possible to use learning models generated by machine learning with neural networks, learning models generated by other machine learning, deep learning algorithms, and mathematical algorithms, such as regression analysis.

Example of Equipment Configuration

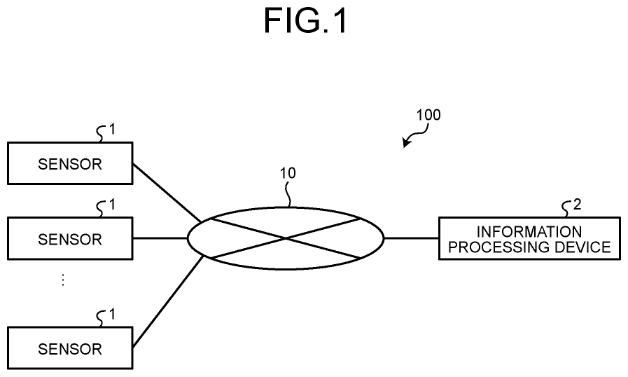

FIG. 1 is a diagram illustrating an example of the equipment configuration of the flow behavior prediction system 100 according to the embodiment. The flow behavior prediction system 100 according to the embodiment includes a plurality of sensors 1 and an information processing device 2. The sensors 1 and the information processing device 2 are connected via a network 10. The communication method of the network 10 may be wired or wireless. The network 10 may be formed of a combination of wired and wireless systems.

Each of the sensors 1 is formed of a fluid sensor or the like. The sensor 1 measures at least one physical quantity, such as fluid velocity, direction, temperature, and pressure, and transmits the physical quantity to the information processing device 2. The data transmitted to the information processing device 2 is time-series data and includes the physical quantity of the fluid, position information thereof, and time. Each of the sensors 1 detects, for example, the velocity and the direction of the fluid for an object. Examples of the fluid include air and liquid. The velocity and the direction of the fluid represent, for example, wind and water flow. Examples of the object include wind turbines and bridges. The sensors 1 are provided, for example, in front of, to the side of, behind, and in the vicinity of the object.

The information processing device 2 acquires, from the sensors 1, first state data including the velocity of the fluid for the object at a first time point and the direction of the fluid at the first time point, via the network 10. The information processing device 2 thereafter estimates second state data including the velocity of the fluid for the object at a second time point that is more advanced than the first time point and the direction of the fluid at the second time point.

The information processing device 2 is incorporated in a control system, for example, in infrastructure equipment. Examples of the control system include systems that control wind turbines and traffic control systems.

Example of Functional Configuration

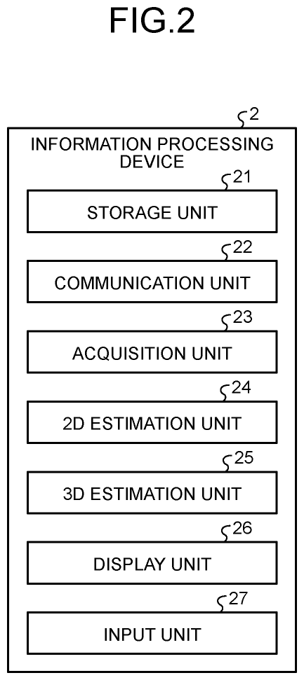

FIG. 2 is a diagram illustrating an example of the functional configuration of the information processing device 2 according to the embodiment. The information processing device 2 according to the embodiment includes a storage unit 21, a communication unit 22, an acquisition unit 23, a two-dimensional (2D) estimation unit 24, a three-dimensional (3D) estimation unit 25, a display unit 26, and an input unit 27.

The storage unit 21 stores information therein. For example, the storage unit 21 stores therein a surrogate model (flow behavior prediction model) used for fluid simulation around the object. For example, the storage unit 21 stores therein 2D data of a plurality of basic shapes forming the object. Examples of the basic shapes include cylinders, square columns, flat plates, elliptical plates, blades of wind turbines, bridge main trusses, piers, and main towers. The 2D data of the basic shapes is used as input data for the surrogate model.

The communication unit 22 communicates with other devices, such as the sensors 1, via the network 10.

The acquisition unit 23 acquires first state data including the velocity of the fluid for the object at the first time point and the direction of the fluid at the first time point.

The 2D estimation unit 24 estimates 2D behavior of the fluid for each of basic shapes using a 2D estimation network to estimate the 2D behavior of the fluid for each of the basic shapes from the first state data and the 2D data of the basic shapes forming the object. The 2D estimation unit 24 thereafter estimates the 2D behavior of the fluid for the object from the 2D behaviors of the fluid for the respective basic shapes. Specifically, the 2D estimation unit 24 estimates the 2D behavior of the fluid for the object formed of a plurality of basic shapes from the 2D behavior of the fluid for the respective basic shapes using a combining network that combines the 2D behaviors of the fluid for the respective basic shapes.

The 3D estimation unit 25 estimates second state data including the velocity of the fluid for the object at a second time point that is more advanced than the first time point and the direction of the fluid at the second time point using a 3D estimation network to estimate 3D behavior of the fluid for the object from the 2D data of the basic shapes forming the object and the 2D behavior of the fluid for the object estimated from the first state data.

The display unit 26 displays information. For example, the display unit 26 displays the second state data described above. The input unit 27 receives an operation input from the user.

Example of Flow Behavior Prediction Method

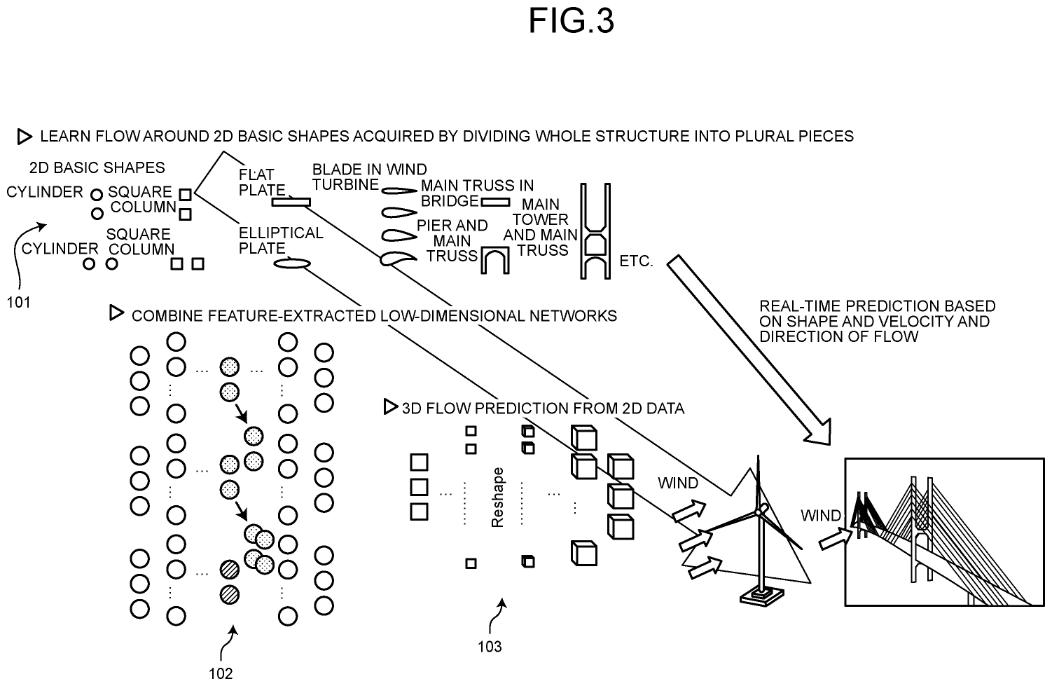

FIG. 3 is a diagram illustrating an example of the flow behavior prediction method according to the embodiment. The flow behavior prediction system 100 according to the embodiment instantly executes fluid simulation around the object, such as an infrastructure structure, using a surrogate model (flow behavior prediction model) created by machine learning in advance. As illustrated in FIG. 3, creation of the surrogate model by machine learning is executed in three stages, in which three networks (2D estimation network 101, combining network 102, and 3D estimation network 103) are coupled to execute the fluid simulation. Each of the networks includes an input layer, one or a plurality of intermediate layers, and an output layer.

The 2D estimation network 101 predicts the flow behavior around itself from the 2D shape. Specifically, the 2D estimation network 101 includes an input layer that receives the 2D data of the basic shapes forming the object, the velocity of the fluid, and the direction of the fluid, one or a plurality of intermediate layers, and an output layer that outputs the 2D flow behavior.

The parameters of the 2D estimation network 101 are subjected to machine learning using teacher data in which input data indicating 2D data of each of the basic shapes is associated with output data acquired by simulating the 2D state of the fluid around the 2D data of each of the basic shapes.

The combining network 102 combines the low-dimensional networks features of which are extracted by the 2D estimation network 101. Specifically, the combining network 102 combines the network structures created by the 2D estimation network 101 to combine the feature-extracted fluid behavior for the basic shapes alone and output the feature-extracted fluid behavior for the whole basic shapes.

The combining network 102 includes parameters to combine the 2D states of the fluid for the pieces of 2D data of the respective basic shapes and extract features of the 2D state of the fluid for the entire 2D data of the basic shapes.

The parameters of the combining network 102 are subjected to machine learning using teacher data in which the input data acquired by simulating the 2D states of the fluid for the pieces of 2D data of the respective basic shapes is associated with the output data indicating the 2D state of the fluid for the entire 2D data of the basic shapes.

The 3D estimation network 103 includes an input layer receiving data indicating the 2D behavior of the fluid, one or a plurality of intermediate layers, and an output layer that outputs data (the second state data described above) indicating the 3D behavior of the fluid. The parameters of the 3D estimation network 103 are subjected to machine learning using teacher data in which input data acquired by simulating the 2D states of the fluid for the 2D data of the basic shapes is associated with output data acquired by simulating the 3D state of the fluid for the object.

Instantaneous three-dimensional flow prediction is enabled by coupling these three networks (2D estimation network 101, combining network 102, and 3D estimation network 103) and executing processing in a sequence from input to the 2D estimation network 101 to output from the 3D estimation network 103.

In other words, the surrogate model (flow behavior prediction model) according to the embodiment is achieved by executing a machine learning model acquired by coupling the 2D estimation network 101, the combining network 102, and the 3D estimation network 103. This machine learning model includes an input layer receiving the first state data and 2D data of basic shapes forming the object, an intermediate layer in which parameters are subjected to machine learning using teacher data with the second state data serving as output, and an output layer that outputs the second state data. This structure enables instantaneous output of 3D flow behavior around the object formed of a plurality of basic shapes as a result of inputting 2D data of the basic shapes.

The example in FIG. 3 is a convolutional neural network (CNN)-based example, but any machine learning method may be used.

It is desirable to use all of the three networks in the order of the 2D estimation network 101, the combining network 102, and the 3D estimation network 103 from the viewpoint of computational speed and computational load, but it is not necessary to use all of the three networks. For example, two of the networks may be used, that is, the 2D estimation network 101 and the 3D estimation network 103 in this order. For example, two of the networks may be used, that is, the combining network 102 and the 3D estimation network 103 in this order.

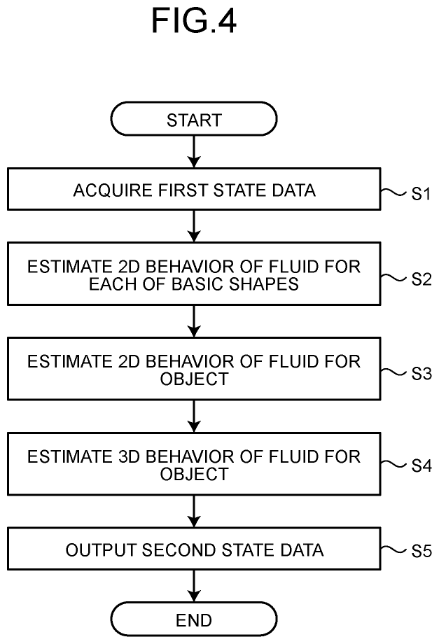

FIG. 4 is a flowchart illustrating an example of the flow behavior prediction method according to the embodiment. First, the acquisition unit 23 acquires the first state data described above (Step S1).

Thereafter, the 2D estimation unit 24 estimates the 2D behavior of the fluid for each of the basic shapes using the 2D estimation network 101 (Step S2). Thereafter, the 2D estimation unit 24 estimates the 2D behavior of the fluid for the object using the combining network 102 (Step S3).

Thereafter, the 3D estimation unit 25 uses the 3D estimation network 103 to estimate the 3D behavior of the fluid for the object (Step S4) and outputs the second state data described above (Step S5).

As explained above, in the flow behavior prediction system 100 according to the embodiment, the storage unit 21 stores therein 2D data of a plurality of basic shapes forming the object. The acquisition unit 23 acquires the first state data including the velocity of the fluid at the first time point and the direction of the fluid at the first time point for the object. The 3D estimation unit 25 estimates the second state data including the velocity of the fluid for the object at the second time point that is more advanced than the first time point and the direction of the fluid at the second time point using the 3D estimation network 103 to estimate the 3D behavior of the fluid for the object from the 2D behavior of the fluid for the object estimated from the 2D data of the basic shapes and the first state data.

This structure enables the flow behavior prediction system 100 according to the embodiment to apply fluid simulation to real-time system operation. For example, in system operation to control wind turbines, control to improve power generation efficiency, etc. can be performed in real time according to wind strength. For example, in operation of a traffic control system, real-time simulation can be executed with respect to the effects of strong winds on vehicles or trains running on a bridge or the like, and control decision and instructions, such as road closures, can be made in real time. In addition, this configuration enables prediction of the degree of damage during typhoons and other strong winds, by determining the loads to which structures are subjected when exposed to wind by linking with structural simulations.

The embodiment described above illustrates the case where the first state data includes the velocity and the direction of the fluid as an example, but the information included in the first state data is not limited to the velocity and the direction of the fluid. For example, the first state data may further include the temperature around the object. In this case, the 2D behavior and the 3D behavior of the fluid further include the temperature distribution around the object. The 3D estimation unit 25 estimates the second state data further including the temperature around the object at the second time point. This configuration enables, for example, an air conditioning system to simulate in real time the temperature distribution in a space, such as an office and a vehicle, and achieve efficient temperature control.

Lastly, the following is an explanation of an example of the hardware configuration of the information processing device 2 according to the embodiment. The information processing device according to the embodiment can be realized, for example, by using any computer device as the basic hardware.

Hardware Configuration Example

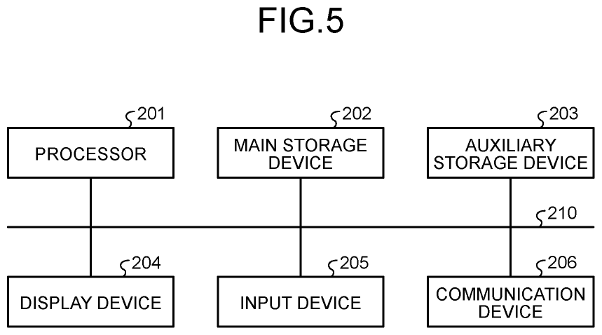

FIG. 5 is a diagram illustrating an example of the hardware configuration of the information processing device 2 according to the embodiment. The information processing device 2 according to the embodiment includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

The information processing device 2 is not required to include some of the above constituent elements. For example, if the information processing device 2 can use an input function and a display function of an external device, the information processing device 2 is not required to include the display device 204 and the input device 205.

The processor 201 executes a computer program read from the auxiliary storage device 203 to the main storage device 202. The main storage device 202 is a memory, such as a ROM and a RAM. The auxiliary storage device 203 is an HDD or a memory card, etc.

The display device 204 is, for example, a liquid crystal display. The input device 205 is an interface to operate the information processing device 2. The display device 204 and the input device 205 may be realized with a touch panel or the like having a display function and an input function. The communication device 206 is an interface to communicate with other devices.

For example, the computer program to be executed by the information processing device 2 is provided as a computer program product in an installable or executable format file recorded on a computer-readable storage medium, such as a memory card, a hard disk, a CD-RW, a CD-ROM, a CD-R, a DVD-RAM, and a DVD-R.

For example, the computer program to be executed by the information processing device 2 may be stored on a computer connected to a network, such as the Internet, and provided by being downloaded via the network.

For example, the computer program to be executed by the information processing device 2 may be configured to be provided via a network, such as the Internet, without being downloaded. Specifically, the flow behavior prediction processing may be configured to be executed by an application service provider (ASP)-type cloud service, for example.

For example, the computer program for the information processing device 2 may be provided in a form of being incorporated in advance in a ROM or the like.

The computer program executed by the information processing device 2 has a module configuration including functions that can also be achieved by the computer program among the functional elements described above. Each of the functional blocks of the functions described above is loaded onto the main storage device 202 by reading and executing the computer program from a storage medium by the processor 201, as actual hardware. In other words, each of the above functional blocks is generated on the main storage device 202.

Some or all of the above functions may be achieved by hardware, such as an integrated circuit (IC), without using software.

A plurality of processors 201 may be used to achieve the functions, in which case each processor 201 may achieve one of the functions or two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A flow behavior prediction system comprising:
a storage unit storing therein two-dimensional data of a plurality of basic shapes forming an object;
one or more hardware processors configured to function as:
an acquisition unit acquiring first state data including a velocity of a fluid for the object at a first time point and a direction of the fluid at the first time point; and
a three-dimensional estimation unit estimating second state data including a velocity of the fluid for the object at a second time point that is more advanced than the first time point and a direction of the fluid at the second time point using a three-dimensional estimation network to estimate a three-dimensional behavior of the fluid for the object from a two-dimensional behavior of the fluid for the object estimated from the two-dimensional data and the first state data.

2. The flow behavior prediction system according to claim 1, wherein the one or more hardware processors are configured to further function as a two-dimensional estimation unit estimating a two-dimensional behavior of the fluid for each of the basic shapes using a two-dimensional estimation network to estimate the two-dimensional behavior of the fluid for each of the basic shapes from the first state data and the two-dimensional data, and estimating the two-dimensional behavior of the fluid for the object from the two-dimensional behavior of the fluid for the each of the basic shapes.

3. The flow behavior prediction system according to claim 2, wherein the two-dimensional estimation unit estimates the two-dimensional behavior of the fluid for the object from the two-dimensional behavior of the fluid for the each of the basic shapes using a combining network that combines two-dimensional behaviors of the fluid for the respective basic shapes.

4. The flow behavior prediction system according to claim 1, wherein parameters of the three-dimensional estimation network are subjected to machine learning using teacher data in which input data acquired by simulating two-dimensional states of the fluid for the two-dimensional data of the basic shapes is associated with output data acquired by simulating a three-dimensional state of the fluid for the object.

5. The flow behavior prediction system according to claim 2, wherein parameters of the two-dimensional estimation network are subjected to machine learning using teacher data in which input data indicating the two-dimensional data of the each of the basic shapes is associated with output data acquired by simulating a two-dimensional state of the fluid around the two-dimensional data of the each of the basic shapes.

6. The flow behavior prediction system according to claim 3, wherein
the combining network includes parameters to combine two-dimensional states of the fluid for pieces of two-dimensional data of the respective basic shapes and extract features of a two-dimensional state of the fluid for entire two-dimensional data of the basic shapes, and
the parameters are subjected to machine learning using teacher data in which input data acquired by simulating the two-dimensional states of the fluid for the pieces of two-dimensional data of the respective basic shapes is associated with output data indicating the two-dimensional state of the fluid for the entire two-dimensional data of the basic shapes.

7. The flow behavior prediction system according to claim 1, wherein
the first state data further includes a temperature around the object,
the two-dimensional behavior and the three-dimensional behavior of the fluid further include a temperature distribution around the object, and
the three-dimensional estimation unit estimates the second state data further including the temperature around the object at the second time point.

8. A flow behavior prediction method implemented by a computer, the method comprising:
storing, by a flow behavior prediction system, two-dimensional data of a plurality of basic shapes forming an object;
acquiring, by the flow behavior prediction system, first state data including a velocity of a fluid for the object at a first time point and a direction of the fluid at the first time point; and
estimating, by the flow behavior prediction system, second state data including a velocity of the fluid for the object at a second time point that is more advanced than the first time point and a direction of the fluid at the second time point using a three-dimensional estimation network to estimate a three-dimensional behavior of the fluid for the object from a two-dimensional behavior of the fluid for the object estimated from the two-dimensional data and the first state data.

9. A computer program product having a non-transitory computer readable medium including programmed instructions stored thereon, wherein the instructions, when executed by a computer, cause the computer to perform:
storing two-dimensional data of a plurality of basic shapes forming an object;
acquiring first state data including a velocity of a fluid for the object at a first time point and a direction of the fluid at the first time point; and
estimating second state data including a velocity of the fluid for the object at a second time point that is more advanced than the first time point and a direction of the fluid at the second time point using a three-dimensional estimation network to estimate a three-dimensional behavior of the fluid for the object from a two-dimensional behavior of the fluid for the object estimated from the two-dimensional data and the first state data.
